(19) United States
(12) Patent Application Publication
(10) Pub. No.: US 2012/0124487 A1
(43) Pub. Date: May 17, 2012

(54) ISSUING BEHAVIORAL AND CONTEXTUAL NOTIFICATIONS

(75) Inventors: Timothy Edgar, Bellevue, WA (US); Igor Avramovic, Kirkland, WA (US)

(73) Assignee: Microsoft Corporation, Redmond, WA (US)

(21) Appl. No.: 12/943,950

(22) Filed: Nov. 11, 2010

(51) Int. Cl. G06F 3/01

(52) U.S. Cl. 715/760

(57) ABSTRACT

The claimed subject matter provides a system and/or method for issuing behavioral and contextual notifications in browser toolbars. An exemplary method comprises discovering usage behaviors and usage context. A trigger event may be defined based on the usage behaviors or the usage context. The trigger may be stored in an application. Information is rendered related to the usage behavior or usage context when the trigger event occurs.

### BACKGROUND

Browsers are software applications that allow users to communicate with the World Wide Web, including the Internet. One function provided by a browser is to allow a user to access Internet websites of interest.

A browser toolbar is an application that works in conjunction with the browser. Typically, the browser toolbar is an add-on to the browser. The toolbar provides access to a set of functions that may be considered convenient by the user. Buttons or other access mechanisms on the toolbar allow a user to access the functions provided by the toolbar. Examples of functions that may be grouped together in a browser toolbar include a search function, a weather information function, a news information function, a map information function or the like. Many toolbars are customizable by the user so that they may provide access to specific functions of interest to the user.

### SUMMARY

The following presents a simplified summary of the innovation in order to provide a basic understanding of some aspects described herein. This summary is not an extensive overview of the claimed subject matter. It is intended to neither identify key nor critical elements of the claimed subject matter nor delineate the scope of the subject innovation. Its sole purpose is to present some concepts of the claimed subject matter in a simplified form as a prelude to the more detailed description that is presented later.

The subject innovation relates to a method and a system for issuing behavioral and contextual notifications in browser toolbars. Usage behaviors and usage context may be discovered while a user is browsing a first website. Trigger events may be defined based on the usage behaviors and the usage context. The trigger event is then stored in an application such as a browser or browser toolbar. Information related to the usage behavior or usage context is rendered when the trigger event occurs.

An exemplary system issues behavioral and contextual notifications in browser toolbars and renders the notifications on an output device. One exemplary system comprises a processing unit and a system memory. The memory system, which comprises a computer-readable storage medium, stores code configured to direct the processing unit to discover usage behaviors or usage context while a user is browsing a first website. Also stored in the system memory is code to direct the processing unit to define a trigger event based on the usage behaviors or the usage context and to store the trigger event in an application. Code stored in the system memory may also be configured to cause the processing unit to render information related to the usage behavior or usage context when the trigger event occurs.

Another exemplary embodiment of the subject innovation provides one or more computer-readable storage media that includes code to direct the operation of a processing unit. The code may direct the processing unit to issue behavioral and contextual notifications in browser toolbars. The computer-readable storage media may comprise code that could direct a processing unit to discover usage behaviors or usage context while a user is browsing a first website. Code stored on the computer-readable storage media may include code configured to define a trigger event based on the usage behaviors or the usage context and code configured to store the trigger in an application. In addition, code stored on the computer-readable storage media may be configured to render information related to the usage behavior or usage context when the trigger event occurs.

The following description and the annexed drawings set forth in detail certain illustrative aspects of the claimed subject matter. These aspects are indicative, however, of but a few of the various ways in which the principles of the innovation may be employed, and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of an exemplary user interface wherein aspects of the claimed subject matter can be employed;

FIG. 2 is a block diagram that is useful in explaining the issuance of behavioral and contextual notifications in browser toolbars according to the subject innovation;

FIG. 3 is a process flow diagram of a method for issuing behavioral and contextual notifications in browser toolbars according to the subject innovation;

FIG. 4 is a block diagram of an exemplary networking environment wherein aspects of the claimed subject matter can be employed; and

FIG. 5 is a block diagram of an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “browser,” “toolbar” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media, such as a computer-readable storage media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for electrical or electronic signals and the like.

Those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

The subject innovation relates to a method and a system for issuing behavioral and contextual notifications in browser toolbars. The behavioral and contextual notifications may be triggered by various sources. In addition, behavioral and contextual notifications may be provided by a website not currently being visited by the user. According to an exemplary embodiment, the behavioral and contextual notifications enhance the experience of websites that have been visited by the user by communicating with the user while browsing other websites.

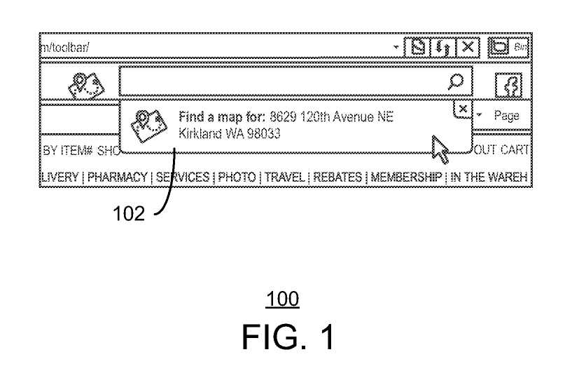

FIG. 1 is an illustration of an exemplary user interface 100, wherein aspects of the claimed subject matter can be employed. The user interface 100 may be a component or portion of a toolbar such as the Bing™ Bar provided by Microsoft Corporation. The user interface 100 may allow specific content providers such as map websites, restaurant websites, local businesses, search engines, online shopping retailers, and travel websites to gather behavioral and contextual information and establish communication with the user. The content providers may suggest functional change in addition to raw information that is useful to the user. Functional changes or other information obtained from the content providers may be presented to a user when certain triggers occur based on the user's behavior within the browser.

A toolbar according to an exemplary embodiment may provide information to the user in the form of a “toast” 102. As used herein, the term “toast” refers to an unobtrusive data display that is proposed to a user. The term “toast” is derived from the data display being compared to a piece of toast that pops up from a toaster. According to an exemplary embodiment, a browser toolbar may be responsible for the management of toasts as well as the presentation of toasts in order to present them in a clear and concise manner to the user. This functionality may be implemented as a toast engine in the browser toolbar.

In the exemplary embodiment shown in FIG. 1, the toast 102 proposed to the user via the user interface 100 offers to find a map of a particular location if the user so desires. According to an exemplary embodiment, the toast 102 is proposed as a result of a triggering event based on the actions of the user. The offer to find a map may be triggered by the user's search for a particular business, the user navigating to a restaurant website, or navigating to a site with reviews of local businesses.

The user interface 100 may also manage the user's actions in response to the toasts, such as navigating users to web pages or setting up features on an associated toolbar. The user may add buttons to the toolbar in response to the toast, and in the case of feature promotion, the toast may have a particular look and feel.

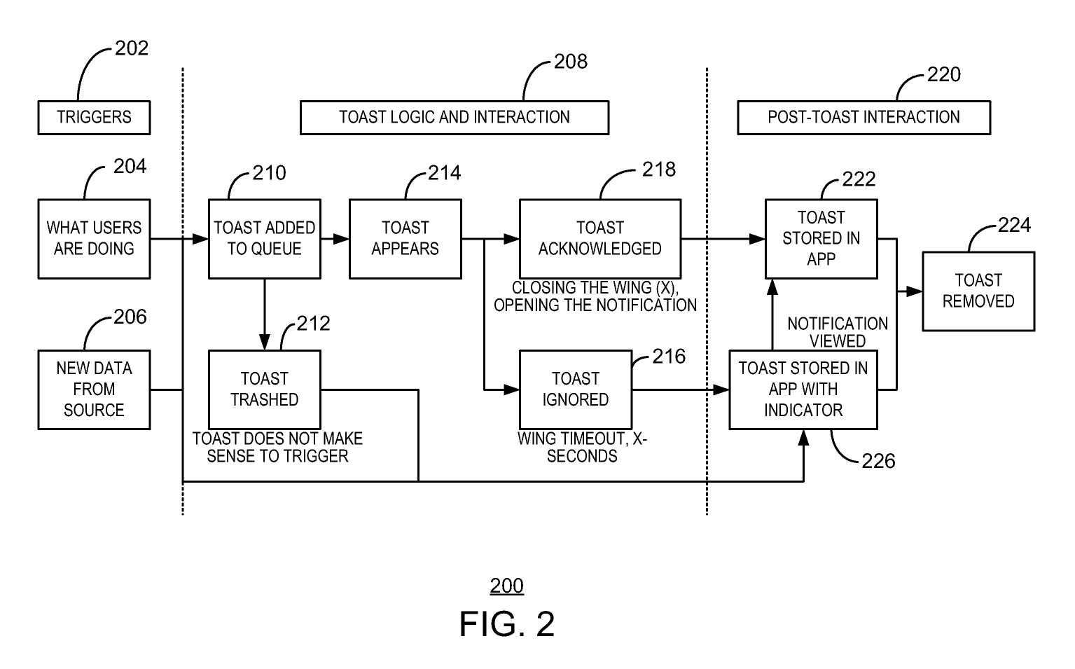

FIG. 2 is a block diagram 200 that is useful in explaining the issuance of behavioral and contextual notifications in browser toolbars according to the subject innovation. Behavioral and contextual notifications can be used to enhance a user's Internet experience in a number of ways. For example, showing reviews of restaurants when the user is searching through listings of restaurants enhances the user's Internet experience by providing useful information that applies to the current tasks being performed by the user. Suggesting and configuring a mail feature based on frequent use of a web mail client allows the web mail client to provide efficient access for the user with minimal interaction from the user. Likewise, offering to find directions or locations when a user is browsing the Internet to find a particular business gives the user the next likely step when browsing in order to find a business; this turns the browsing experience into a well planned, methodical process.

Another example of enhancing the user's Internet experience is suggesting the addition of a sports team to the toolbar after the user makes frequent visits to websites related to a particular team. In this scenario, the user's Internet experience is enhanced by giving the user a central location to access information of interest. Similarly, the toolbar itself can be configured based on repeat action within the toolbar. These examples are meant to be simply illustrative and not exhaustive.

A method according to the diagram 200 employs one or more trigger events 202 to provide useful information to a user based on behavioral or contextual activity in a browser. The trigger events 202 may be defined based on what a user is doing, as shown at block 204. At block 206, new data from a source may also be used to define trigger events. Examples of trigger events may be based on information derived from the browser history, including webpages frequently visited by the user. The subject innovation may take the browser history as a whole and analyze the user's browsing history in order to extract pattern may be used to initiate the trigger. The trigger events 202 may then be formulated based on the common themes throughout the user's browser history. Furthermore, when the user performs a triggering action or actions corresponding to trigger events on a different website, content is displayed to the user, even though the user is not currently viewing the website that defined the triggering event. For example, the user may not be viewing a website capable of giving directions to a particular business location, but when the user is browsing to a website with that particular business, the subject innovation is able to send the user directions to that particular business location. In this manner, the website capable of giving directions, as a content provider, can enqueue information to show at a particular time and register the content to show for a specific trigger. The trigger event may occur some time after the information has been enqueued, and at that point in time the information may be rendered.

Another example of a trigger event 202 may be a Uniform Resource Locator (URL) of the current webpage the user is visiting. The subject innovation may determine common tasks associated with a particular URL and form a trigger event 202 based on the URL. Further, the URL may be configured to send data to the browser for use as a trigger. In addition, open tabs within a browser can form a trigger event 202 that may be based on the context of each tab. Certain browser events and the time after certain browser events occur may also be used as a trigger event 202. Browser events are based on activity within the browser; examples of browser events include when the document has loaded, before the browser navigates to a new webpage, when the user clicks within the browser, when the user presses a key within the browser, and when the user places the cursor over particular areas within the browser. “Time after browser events occur” triggers may take place after any designated length of time after a browser event.

Activity within the browser, whenever it occurs, may also be a trigger event 202. Activity within the browser may entail knowing that the user is at the machine in a specific mode. For example, the user may be using the computer with the browser running in the background, or the user may be away from the computer all together. Under each circumstance, a trigger event 202 may be based on activity within the browser. Other examples of trigger events 202 may include the history of interaction between the user and the user interface elements located in the toolbar. Historical data tracking clicks within in the toolbar may also be used as a trigger.

The trigger events 202 may be used to signal the generation of context-related information, which may be used to render information related to the trigger to a user in the form of, for example, a toast. The information provided as a result of the occurrence of actions corresponding to a trigger event may originate from a website not currently being visited by a browser. Further, the information may be stored when the triggering event is defined. The stored information may come from a web service that takes triggers to return real-time information. Moreover, a browser or browser toolbar according to the subject innovation may collect behavioral and contextual information for use in triggering the presentation of information from a website to a user at the appropriate time. When the user performs an activity that corresponds to a trigger event in the browser, the information related to the triggering event may be displayed to the user.

A region 208 of the diagram 200 represents the operation of toast logic and interaction in a browser or browser toolbar according to an exemplary embodiment. At block 210, a toast is added to a queue in response to the occurrence of a triggering event. If the toast is not relevant to the user at the time of addition to the queue, the toast is suppressed or deleted from the queue (trashed), as shown at block 212 and process flow continues to a region 220 of the diagram 200 representing post-toast interaction. In particular, process flow continues at block 226, where the toast may be stored in an application with an indicator. The indicator may represent a reason why the toast was removed from the queue without being displayed to the user. An example of why the toast may not be displayed to the user is a scenario in which the user navigates away from a website before the information relative to the website is rendered. After the user navigates away from the website, the information is trashed because it is no longer relevant and as such, it no longer makes sense to render this information to the user.

At block 214, the toast appears to the user in the form of a notification or alert. The toast may either be acknowledged by the user (block 218) or ignored (block 216). The user may click on the notification portion of the toast to perform an action suggested by the toast or click on close icon to ignore or suppress the toast. If the toast is ignored by the user, process flow continues to block 226. Moreover, the user is likely to respond favorably to the toast if the toast provides information or offers an action that is helpful to the user. If the toast is acknowledged, process flow continues at block 222.

As described above, the region 220 of the diagram 200 relates to post-toast interaction according to an exemplary embodiment. Process flow arrives at block 222 after a toast has been acknowledged by a user. The toast is stored in an application, such as the browser toolbar. If a toast has been trashed (block 212) or ignored (block 216), process flow arrives at block 226, where the toast may be stored with an indicator that it was either trashed or ignored. The indicator may attach to all toasts not viewed by the user, including toasts that the user purposefully did not acknowledge or toasts where the user simply did not pay attention. The content of the toast, when applicable, is stored for future consumption when the toast fades naturally or when the toast engine decides to save the toast. The toast engine may save the toast instead of rendering the toast when the queue is long.

If the user repeatedly closes, or ignores the toasts, the user establishes a history of negative reaction to that particular toast. As a result, the toast may no longer be rendered to the user. Another option is for the user to take toasts that the user favors and configure specific features related to a particular toast on the toolbar.

When the notification is viewed, process flow continues at block 222. Activity may also be detected within the browser to determine that the user is at the machine in a specific mode, as opposed to the browser being in the background. When the browser is in the background, toasts may be stored within the browser application until they can be viewed by the user. Each toast may have an associated “time to live.” The toast may expire to trash after the time to live has passed. At block 224, the toast is removed. A toast may be removed when the user has sufficiently consumed the information within the toolbar application. The sufficient consumption may be determined based on a time the toast is displayed, where the toast will expire after a set time period. Additionally, browser applications may provide a suggested time for how long the alert should live. The alert is trashed if the alert cannot be rendered before time expires.

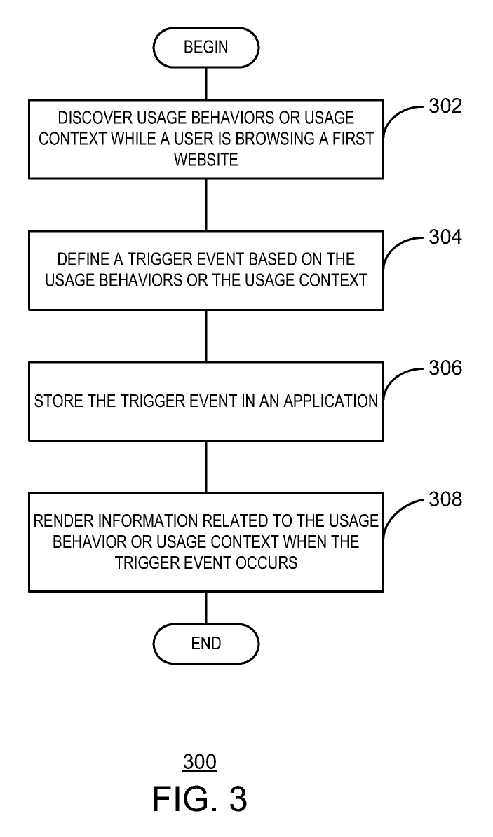

FIG. 3 is a process flow diagram of a method for issuing behavioral and contextual notifications in browser toolbars. At block 302, usage behaviors and usage contexts may be discovered while a user is browsing a first website. At block 304, a trigger event is defined based on the usage behaviors and the usage context. At block 306, the trigger event is stored in an application, such as a browser toolbar or other browser component. At block 308, information related to the usage behaviors or usage context in rendered to the user when an action corresponding to the trigger event occurs. The information may be rendered to the user in the form of a toast, for example.

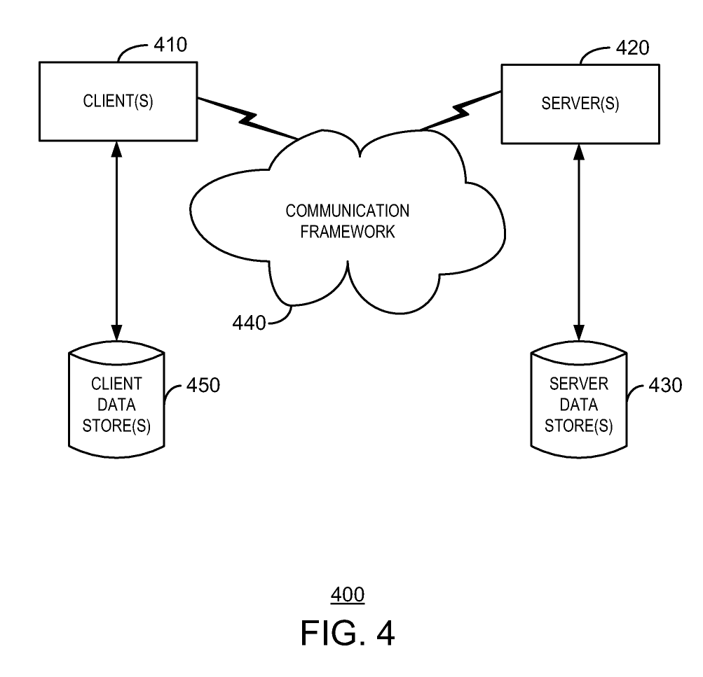

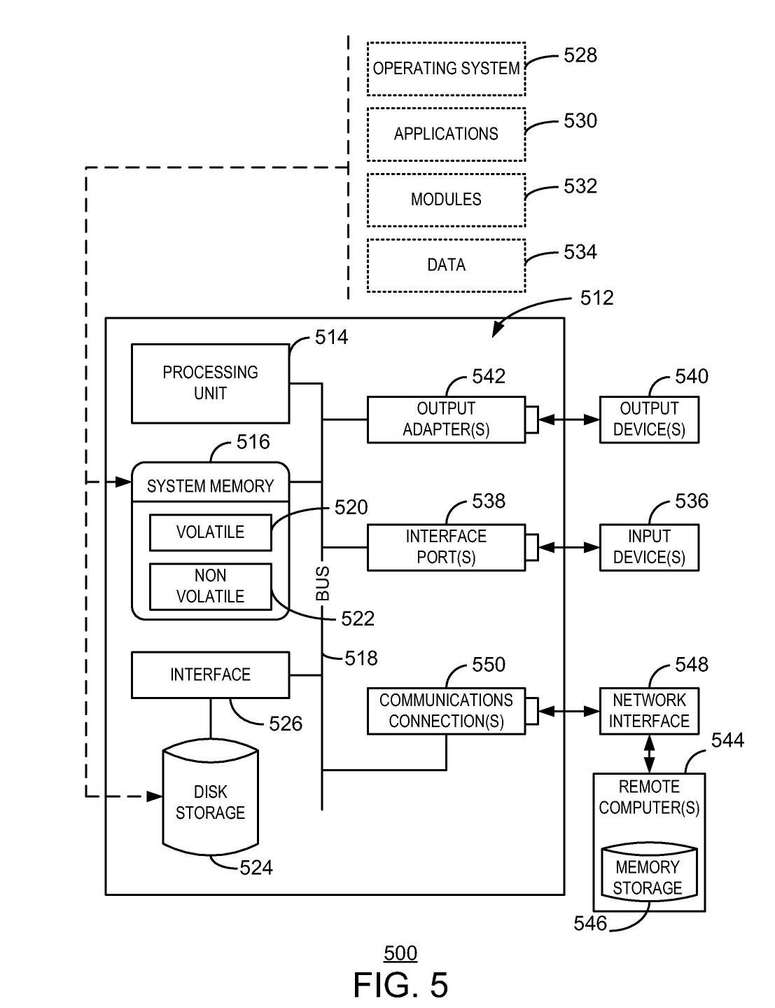

In order to provide additional context for implementing various aspects of the claimed subject matter, FIGS. 4-5 and the following discussion are intended to provide a brief, general description of a suitable computing environment in which the various aspects of the subject innovation may be implemented. For example, behavioral and contextual notifications, as described in the previous figure, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the subject innovation may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 4 is a schematic block diagram of a sample-computing system 400 with which behavioral and contextual notifications can be issued in browser toolbars. The system 400 includes one or more client(s) 410. The client(s) 410 can be hardware and/or software (e.g., threads, processes, computing devices). The system 400 also includes one or more server(s) 420. The server(s) 420 can be hardware and/or software (e.g., threads, processes, computing devices).

One possible communication between a client 410 and a server 420 can be in the form of a data packet adapted to be transmitted between two or more computer processes. This data packet may contain data to form a trigger or in response to a trigger. The system 400 includes a communication framework 440 that can be employed to facilitate communications between the client(s) 410 and the server(s) 420. The client(s) 410 are operably connected to one or more client data store(s) 450 that can be employed to store information local to the client(s) 410. Information in the data store(s) 450 may be toast in the queue, which may be rendered to the user. The client data store(s) 450 do not have to be in the client(s) 410, but may be located remotely, such as in a cloud server. Similarly, the server(s) 420 are operably connected to one or more server data store(s) 430 that can be employed to store information local to the servers 420.

As an example, the client(s) 410 may be computers providing access to the Internet over a communication framework 440. The server(s) 420 may host websites accessed by the client, which may send various information of interest to a user when a trigger event takes place as explained herein.

With reference to FIG. 5, an exemplary environment 500 for implementing various aspects of the claimed subject matter includes a computer 512. The computer 512 includes a processing unit 514, a system memory 516, and a system bus 518. The system bus 518 couples system components including, but not limited to, the system memory 516 to the processing unit 514. The processing unit 514 can be any of various available processors. Dual microprocessors and other multiprocessor architectures also can be employed as the processing unit 514.

The system bus 518 can be any of several types of bus structure(s) including the memory bus or memory controller, a peripheral bus or external bus, and/or a local bus using any variety of available bus architectures known to those of ordinary skill in the art.

The system memory 516 may include non-transitory computer-readable storage media comprising volatile memory 520 and nonvolatile memory 522. The basic input/output system (BIOS), containing the basic routines to transfer information between elements within the computer 512, such as during start-up, is stored in nonvolatile memory 522. By way of illustration, and not limitation, nonvolatile memory 522 can include read only memory (ROM), programmable ROM (PROM), electrically programmable ROM (EPROM), electrically erasable programmable ROM (EEPROM), or flash memory.

Volatile memory 520 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 512 also includes other non-transitory computer-readable media, such as removable/non-removable, volatile/non-volatile computer storage media. FIG. 5 shows, for example a disk storage 524. Disk storage 524 includes, but is not limited to, devices like a magnetic disk drive, floppy disk drive, tape drive, Jaz drive, Zip drive, LS-100 drive, flash memory card, or memory stick.

In addition, disk storage 524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 524 to the system bus 518, a removable or non-removable interface is typically used such as interface 526.

It is to be appreciated that FIG. 5 describes software that acts as an intermediary between users and the basic computer resources described in the suitable operating environment 500. Such software includes an operating system 528. Operating system 528, which can be stored on disk storage 524, acts to control and allocate resources of the computer system 512.

System applications 530 take advantage of the management of resources by operating system 528 through program modules 532 and program data 534 stored either in system memory 516 or on disk storage 524. It is to be appreciated that issuing behavioral and contextual notifications in browser toolbars matter can be implemented with various operating systems or combinations of operating systems. The browser that the user employs to access the Internet may be a program module 532.

A user enters commands or information into the computer 512 through input device(s) 536. Input devices 536 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 536 connect to the processing unit 514 through the system bus 518 via interface port(s) 538. Interface port(s) 538 include, for example, a serial port, a parallel port, a game port, and a universal serial bus (USB).

Output device(s) 540 use some of the same type of ports as input device(s) 536. Thus, for example, a USB port may be used to provide input to the computer 512, and to output information from computer 512 to an output device 540. Information rendered by the subject innovation may appear on an output device 540.

Output adapter 542 is provided to illustrate that there are some output devices 540 like monitors, speakers, and printers, among other output devices 540, which are accessible via adapters. The output adapters 542 include, by way of illustration and not limitation, video and sound cards that provide a means of connection between the output device 540 and the system bus 518. It can be noted that other devices and/or systems of devices provide both input and output capabilities such as remote computer(s) 544.

The computer 512 can be a server hosting a website in a networked environment using logical connections to one or more remote computers, such as remote computer(s) 544. The remote computer(s) 544 may be client systems configured with web browsers, PC applications, mobile phone applications, and the like, to allow users to browse the Internet, as discussed herein. The client web browser may be enhanced by issuing behavioral and contextual notifications in browser toolbars. The remote computer(s) 544 can be a personal computer, a server, a router, a network PC, a workstation, a microprocessor based appliance, a mobile phone, a peer device or other common network node and the like, and typically includes many or all of the elements described relative to the computer 512. For purposes of brevity, only a memory storage device 546 is illustrated with remote computer(s) 544. Remote computer(s) 544 is logically connected to the computer 512 through a network interface 548 and then physically connected via a communication connection 550.

Network interface 548 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 550 refers to the hardware/software employed to connect the network interface 548 to the bus 518. While communication connection 550 is shown for illustrative clarity inside computer 512, it can also be external to the computer 512. The hardware/software for connection to the network interface 548 may include, for exemplary purposes only, internal and external technologies such as, mobile phone switches, modems including regular telephone grade modems, cable modems and DSL modems, ISDN adapters, and Ethernet cards.

An exemplary embodiment of the computer 512 may comprise a client computer with a web browser. An exemplary processing unit 514 for the client may be a computing cluster comprising Intel® Xeon CPUs. The disk storage 524 may comprise an enterprise data storage system, for example, holding thousands of user pages. Exemplary embodiments of the subject innovation may issue behavioral and contextual notifications in browser toolbars.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for issuing behavioral and contextual notifications, the method comprising:
discovering usage behaviors or usage context while a user is browsing a first website;
defining a trigger event based on the usage behaviors or the usage context;
storing the trigger event in an application; and
rendering information related to the usage behavior or usage context when the trigger event occurs.

2. The method recited in claim 1, wherein the application comprises a browser component.

3. The method recited in claim 2, wherein the browser component comprises a browser toolbar.

4. The method recited in claim 1, wherein the information comprises an offer to perform an action.

5. The method recited in claim 1, wherein the trigger event comprises a history of web events, a browser event, or a Uniform Resource Locator.

6. The method recited in claim 1, wherein the trigger event is based on a number of tabs within a browser, interaction with a user interface located within a toolbar, or clicks within the toolbar.

7. The method recited in claim 1, comprising rendering the information to the user as a toast.

8. A system for issuing behavioral and contextual notifications, the system comprising:
a processing unit; and
a system memory, wherein the system memory comprises code configured to direct the processing unit to:
discover usage behaviors or usage context while a user is browsing a first website;
define a trigger event based on the usage behaviors or the usage context;
store the trigger event in an application; and
render information related to the usage behavior or usage context when the trigger event occurs.

9. The system recited in claim 8, wherein the application comprises a browser component.

10. The system recited in claim 9, wherein the browser component comprises a browser toolbar.

11. The system recited in claim 8 wherein the information comprises an offer to perform an action.

12. The system recited in claim 8, wherein the trigger event comprises a history of web events, a browser event, or a Uniform Resource Locator.

13. The system recited in claim 8, wherein the trigger event is based on a number of tabs within a browser, interaction with a user interface located within a toolbar, or clicks within the toolbar.

14. The system recited in claim 8 comprising rendering the information to the user as a toast.

15. One or more computer-readable storage media, comprising code configured to direct a processing unit to:
discover usage behaviors or usage context while a user is browsing a first website;
define a trigger event based on the usage behaviors or the usage context;
store the trigger in an application; and
render information related to the usage behavior or usage context when the trigger event occurs.

16. The one or more computer-readable storage media recited in claim 15, wherein the application is a browser component.

17. The one or more computer-readable storage media recited in claim 16, wherein the browser component comprises a browser toolbar.

18. The one or more computer-readable storage media recited in claim 15, wherein the information comprises an offer to perform an action.

19. The one or more computer-readable storage media recited in claim 15, wherein the trigger event is based on a number of tabs within a browser, interaction with a user interface located within a toolbar, clicks within the toolbar, a history of web events, a browser event, or a Uniform Resource Locator.

20. The one or more computer-readable storage media recited in claim 15, comprising rendering the information to the user as a toast.
